(19) United States
(12) Patent Application Publication
(10) Pub. No.: US 2018/0220582 A1
(43) Pub. Date: Aug. 9, 2018

(54) DISPOSABLE QUICK-CONNECT CUTTER HEAD ASSEMBLY FOR A ROTARY TRIMMER

(71) Applicant: Fred Trombino, Lake Lure, NC (US)

(72) Inventor: Fred Trombino, Lake Lure, NC (US)

(21) Appl. No.: 15/877,745

(22) Filed: Jan. 23, 2018

Related U.S. Application Data
(60) Provisional application No. 62/456,313, filed on Feb. 8, 2017.

(51) Int. Cl. A01D 34/416

(52) U.S. Cl. CPC A01D 34/4165

(57) ABSTRACT

A cutting head assembly is provided having a cutting head with a housing with a cavity therein for holding a spool of filament. The housing has an upper surface with an opening defining a connection opening. The housing is non-releasably sealed together and disposable. The cutting head assembly further includes a connection adaptor. The connection adaptor has opposite first and second ends spaced apart in an axial direction. The first end of the connection adaptor is configured to be lockably engaged in the connection opening. The second end of the connection adaptor is configured to be lockably engaged in a shaft portion. The cutting head may be quickly released from the connection adaptor and replaced with a new cutting head.

This application claims priority on U.S. Provisional Application No. 62/456,313 filed on Feb. 8, 2017.

### BACKGROUND OF THE INVENTION

### Field of the Invention

The present disclosure relates to a disposable quick-connect and disconnect head for a trimmer assembly.

### Description of the Related Art

Cutting heads for trimmers are well known in the art. Typically, a cutting head comprises a housing having upper and lower portions. A spool of filament is arranged in the housing between the upper and lower portions. The housing is assembled by connecting the upper and lower portions. The upper and lower portions may fit in a snap-type connection. When assembled, the housing includes an upper surface, a lower surface, and a side-surface extending therebetween. At least one, and preferably two, openings are provided on the side surface of the housing. Ends of the spooled filament are drawn-out through the openings. The drawing-out process of the filament may be completed manually (i.e. a user may pull the filament out of each opening) or by a tap-operated ratchet mechanism.

The typical cutting head is also provided with a means for connection to a shaft. The connection means may be a threaded opening in the upper surface of the trimmer head sized to receive a threaded protuberance on an end of the shaft. Alternatively, the connection means could comprise a snap-fit connection. However, there are drawbacks to the prior art connection means.

Trimmer heads are generally marketed and sold to both individuals and landscapers. An individual usually only uses a trimmer head on their own personal property. The individual may only use the trimmer once a week or once a month. Such infrequent use leads to a long lifespan for the at-home user. However, professional landscapers may use a trimmer on dozens of properties every day. As a result, the cutting head experiences more wear and tear and the filament must be replaced often. Further, the materials used to make both the cutting head and the filament must be strong enough to withstand the constant use of a landscaping professional. As a result, the cutting heads become more costly to produce.

Still further, the landscaping professional and individual user alike require cutting heads that can be quickly disassemble and reassembled for the replacement of the filament. There is a significant inconvenience associated with the disassembly of the cutting head and filament loading. The filament often becomes tangled when loaded, thereby effecting the performance of the cutting head. Further, the user must disassemble the trimmer head and unwind the filament in order to remove the tangle. The need for a quick assembly is often met at the expense of the strength of the cutting head, and ultimately the lifespan of the product.

In view of the above, an object of the present invention is to provide a cutting head assembly that can be quickly and simply connected and disconnected from a trimmer shaft or trimmer gear box.

It is a further object of the invention to provide a cutting head assembly with a sealed housing and preloaded with filament ready for use.

It is a further object of the invention to provide a cutting head assembly that can be made inexpensively and is disposable.

### SUMMARY

A cutting head assembly is provided. The cutting head assembly has a housing. The housing is generally circular when viewed from above. The housing may include a lower concave portion and an upper concave portion joined together and defining a cavity therebetween. Each of the lower and upper portions comprise a lower substantially planar surface and a circumferential side wall projecting therefrom. One of the lower and upper portions may partially nest in the other of the lower and upper portions so that one of the circumferential side walls is inserted into the other one of the circumferential side walls in close-fitting contact. When assembled, the housing comprises opposite upper and lower surfaces and a side wall extending therebetween. At least one, and preferably two, openings are provided on the side wall.

The housing assembly described above is not limited to the recited embodiment. Alternatively, the housing may include a lower portion with a circumferential side wall as described above, and an upper substantially planar cap that is fitted on the lower portion. In another embodiment, the housing comprises first and second side portions that are semi-circular when viewed from above and are joined together. Still further, the housing may define a closed cylinder having an opening through which a spool of filament (to be defined below) can be inserted. The spool of filament is mounted on a prior art filament advancing mechanism. For instance, the filament may be pulled out through the at least one opening manually, or may be advanced via operation of a bump plate located on the lower surface. Further, the spool of filament is operationally rotated by a prior art spinning mechanism. The spinning mechanism receives power and a rotational force via a shaft connected to the cutting head (to be described) to rotate the cutting head in a clockwise or counter-clockwise direction.

The lower and upper portions of the housing are non-releasably connected to one another. The lower and upper portions may be adhesively fixed to each other, may be heat sealed, or may be non-releasably connected by any means now known or later developed. As a result, the cutting head housing can be made inexpensively because connection and disconnection means do not need to be included in the design. Further, the spool of filament cannot be replaced because the housing cannot be opened, thereby rendering the cutting head disposable. Therefore, the cutting head can be manufactured inexpensively because the materials used to produce the housing only need stand up to the wear and tear associated with a single spool of filament.

The upper surface of the housing is provided with a connection opening for connection to the shaft. In the preferred embodiment, the connection opening includes a substantially circular portion and includes first and second notches extending radially from the circular portion. However, the connection opening may include more than two notches. The first and second notches are L-shaped when viewed cross-sectionally.

A connection adaptor is provided to facilitate a quick connection between the cutting head or shaft that comprises a quick connection. The connection adaptor or shaft and gearbox comprises a first end and a second end spaced axially from the first end. First and second tabs extend from the first end in a direction normal to an axial direction of the connection adaptor. The second end includes a threaded projection configured to mate with a threaded opening in the shaft.

The first and second tabs are sized and spaced to fit into the notches with a portion of the connection adaptor between the first and second ends inserted into the circular portion. The connection adaptor is rotated so that the first and second tabs are lockably engaged in the L-shaped notches.

In operation, the connection adaptor is inserted into and locked in the connection opening. The second end of the connection adaptor is threadably fixed to the shaft. A user operates the trimmer until the spool of filament is spent. The cutting head is then disconnected from the trimmer unit and discarded. A new cutting head is then connected to the trimmer.

In an alternate embodiment, the connection adaptor is formed as a portion of the shaft. In this embodiment, the second end of the connection adaptor may be formed integrally on an end of the shaft. Alternatively, the connection adaptor may be releasably or non-releasably attached to the end of the shaft. In this regard, the connection adaptor may be sold or packaged as a component of the shaft. In operation, the first end of the connection adaptor is inserted into and locked to the connection opening of the cutting head. When the spool of filament in the cutting head is spent, the trimmer head is removed and a new trimmer head is attached directly connection adaptor.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a perspective view of a trimmer shaft.

FIG. 2A is a front view of a connection adaptor in accordance with the invention.

FIG. 2B is a bottom plan view of the connection adaptor.

FIG. 2C is a side view of the connection adaptor

FIG. 2D is a front view of a connection adaptor.

FIG. 3 is a perspective view of a cutting head in accordance with the invention.

FIG. 4 is a top plan view of the cutting head.

FIG. 5 is a cross-sectional view of the cutting head.

FIG. 6 is a perspective view of a cutting head and shaft in accordance with a second embodiment of the invention.

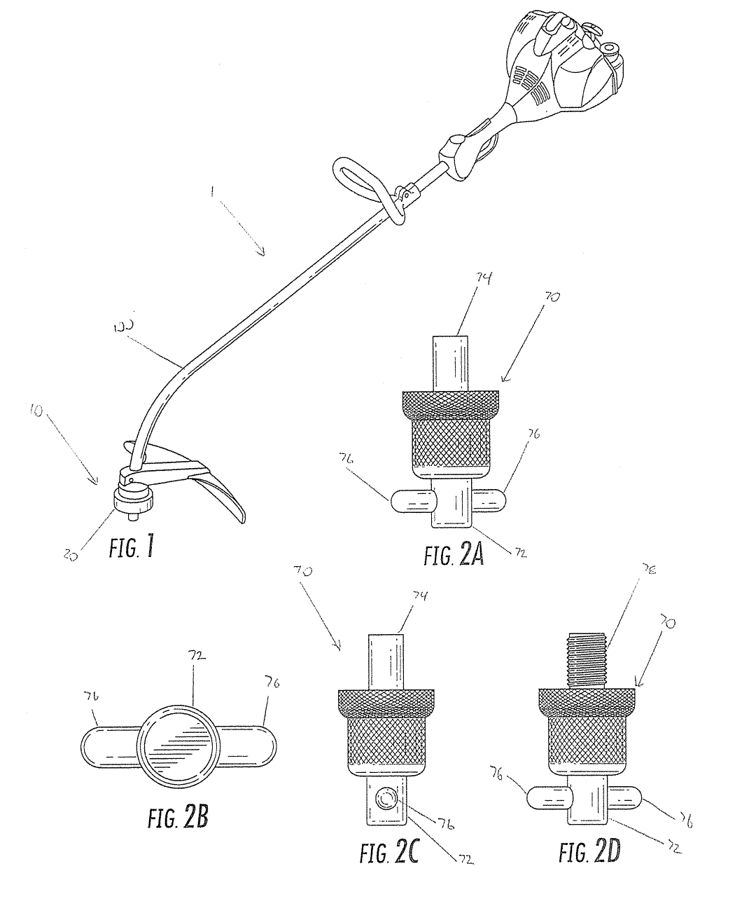

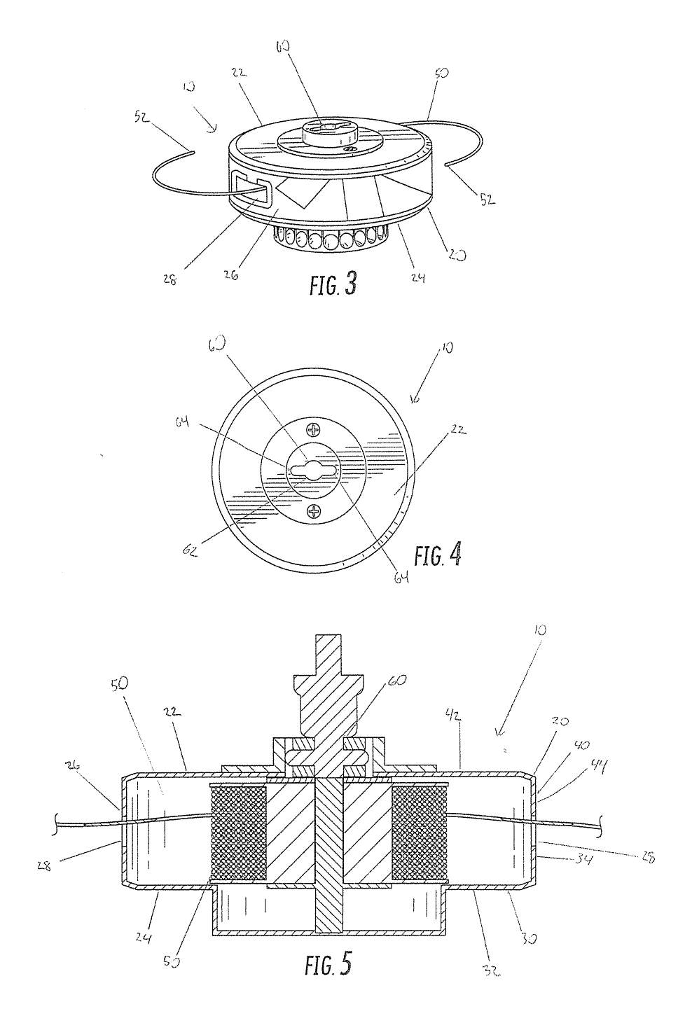

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A cutting head assembly 10 for a trimmer 1 is provided. The cuffing head assembly 10 includes a housing 20. The housing 20 is generally circular when viewed from above. The housing 20 may include a lower concave portion 30 and an upper concave portion 40 joined together and defining a cavity 50 therebetween. Each of the lower and upper portions 30, 40 comprise a substantially planar surface 32, 42 and a circumferential side wall 34, 44 projecting therefrom. One of the lower and upper portions 30, 40 may partially nest in the other of the lower and upper portions 30, 40 so that one of the circumferential side walls 34, 44 is inserted into the other one of the circumferential side walls 34, 44 in close-fitting contact. When assembled, the housing 20 comprises opposite upper and lower surfaces 22, 24 and a side wall 26 extending therebetween. At least one, and preferably two, openings 28 are provided on the side wall 26.

The housing assembly 20 described above is not limited to the recited embodiment. Alternatively, the housing 20 may include the lower portion 30 with a circumferential side wall 32 as described above, and an upper substantially planar cap that is fitted on the lower portion 30. In another embodiment, the housing 20 comprises first and second side portions that are semi-circular when viewed from above and are joined together. Still further, the housing 20 may define a closed cylinder having an opening through which a spool of filament 50 (to be defined below) can be inserted.

The spool of filament 50 is mounted on a prior art filament advancing mechanism. For instance, ends 52 of the filament 50 may be pulled out through the at least one opening 28 manually, or may be advanced via operation of a bump plate 28 located on the lower surface 24. Further, the spool of filament 50 is operationally rotated by a prior art spinning mechanism. The spinning mechanism receives power and a rotational force via a shaft 100 connected to the cutting head assembly 10 to rotate the cutting head assembly 10 in a clockwise or counter-clockwise direction. The shaft 100 has a first end 101 connected to a gear box 102 for providing power to the cutting head assembly 10 and a second end 103 opposite the first end 101. The second end 103 is defined by an opening 104 to facilitate connection with the cutting head assembly 10. The opening 104 is preferably internally threaded.

The lower and upper portions 30, 40 of the housing 20 are non-releasably connected to one another. The lower and upper portions 30, 40 may be adhesively fixed to each other, may be heat sealed, or may be non-releasably connected by any means now known or later developed. As a result, the housing 20 can be made inexpensively because connection and disconnection means do not need to be included in the design. Further, the spool of filament cannot be replaced because the housing cannot be opened, thereby rendering the cutting head assembly 10 disposable. Therefore, the cutting head assembly 10 can be manufactured inexpensively because the materials used to produce the housing 20 only need stand up to the wear and tear associated with a single spool of filament 50.

The upper surface 22 of the housing 20 is provided with a connection opening 60 for connection to the shaft 100. In the preferred embodiment, the connection opening 60 includes a substantially circular portion 62 and includes first and second notches 64 extending radially from the circular portion 62. However, the connection opening 60 may include more than two notches 64. The first and second notches 64 are L-shaped when viewed cross-sectionally.

A connection adaptor 70 is provided to facilitate a quick connection between the cutting head assembly 10 and the shaft 100. The connection adaptor 70 comprises a first end 72 and a second end 74 spaced axially from the first end 72. First and second tabs 76 extend from the first end 72 in a direction normal to an axial direction of the connection adaptor 70. The second end 74 may include a threaded projection 78 configured to mate with the opening 104 on the second end 103 of the shaft 100.

The first and second tabs 76 are sized and spaced to fit into the notches 64 with a portion of the connection adaptor 70 between the first and second ends 72, 74 inserted into the circular portion 62. The connection adaptor 70 is rotated so that the first and second tabs 76 are lockably engaged in the L-shaped notches 64.

In operation, the second end 74 of the connection adaptor 70 is inserted into the opening 104 on the second end 103 of the shaft 100. Next, the first end 72 of the connection adaptor 74 is inserted into the connection opening 60 with the first and second tabs 76 aligned with the notches 64. The connection adaptor 74 is rotated into a locked position. A user operates the trimmer until the spool of filament 50 is spent. The cutting head assembly 10 is then disconnected from the connection adaptor 70 and discarded. A new cutting head 10 is then connected to the connection adaptor.

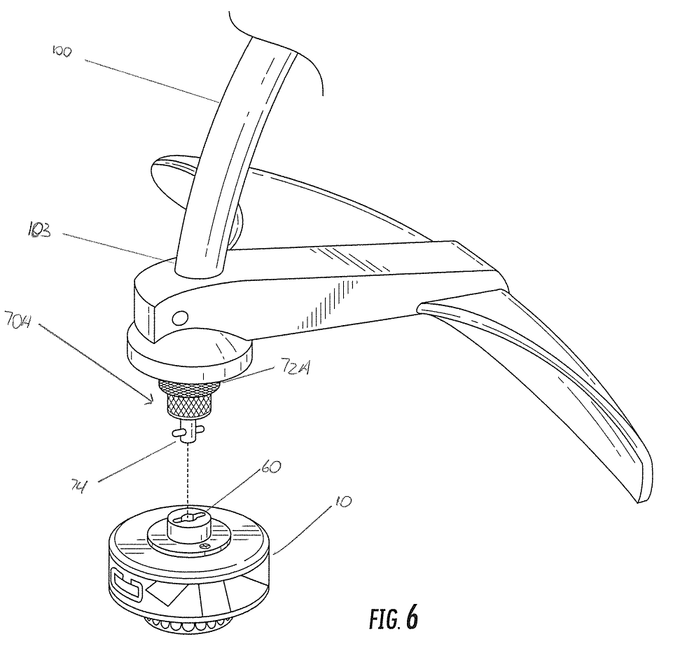

In a second embodiment illustrated in FIG. 6, a connection adaptor 70A is formed on an end of the shaft 100. In particular, the second end 74A of the connection adaptor 70A is integrally formed with the second end 103 of the shaft 100, or otherwise releasably or non-releasably connected to the second end 103 of the shaft 100. In operation, the first end 72A of the connection adaptor 70A is inserted into and locked to the connection opening 60 of the cutting head 10 in the same operation described with respect to the first embodiment. When the spool of filament 50 in the cutting head 10 is spent, the cutting head 10 is removed and a new trimmer head is attached directly connection adaptor 70A.

While the disclosure has been shown and described with reference to certain preferred embodiments thereof, it will be understood by those skilled in the art that various changes in form and detail may be made therein without departing from the spirit and scope of the disclosure.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112.

What is claimed is:

1. A cutting head assembly to be releasably attached to a shaft or gear box, the cutting head assembly comprising:
a cutting head having a housing, the housing including at least an upper surface and a lower surface;
a connection opening formed in the upper surface of the housing; and
a connection adaptor having first and second ends spaced axially from each other, the first end configured to be releasably engaged in the connection opening, and the second end configured to be releasably engaged in the shaft.

2. The cutting head assembly of claim 1, wherein the housing comprises a lower concave portion having a surface and a circumferential side wall projecting normal to the surface, an upper concave portion including the upper surface of the housing and a circumferential side wall projecting normal to the upper surface, and wherein
the lower and upper concave portions are joined together to define a cavity therebetween.

3. The cutting head assembly of claim 2, wherein the lower concave portion and the upper concave portion are non-releasably sealed together.

4. The cutting head assembly of claim 2, wherein at least one opening is formed in at least one of the circumferential side walls of the lower and upper concave portions.

5. The cutting head assembly of claim 4, wherein a spool of filament is housed in the housing, and a leading end of the spool of filament is pulled out through the opening.

6. The cutting head assembly of claim 1, wherein the connection opening includes a substantially circular main portion extending into the housing in a direction normal to the upper surface, and at least one notch extending radially outward of the circular main portion.

7. The cutting head assembly of claim 6, wherein the at least one notch comprises first and second notches extending radially outward of the circular main portion in opposite directions.

8. The cutting head assembly of claim 6, wherein the connection adaptor includes a main body portion and at least one tab projecting radially outward from the main body portion in a direction normal to the axial direction, and wherein the at least one tab is configured to be inserted into the at least one notch in the connection opening.

9. The cutting head assembly of claim 7, wherein the second end of the connection adaptor is threaded.

10. A trimmer unit, comprising:
a cutting head having a housing, the housing including at least an upper surface, and a connection opening formed in the upper surface of the housing;
a connection adaptor having first and second ends spaced apart in an axial direction, the first end configured to be releasably engaged in the connection opening; and the second end being threaded; and
a shaft having opposite first and second ends spaced apart in the axial direction, and an opening formed in the second end of the shaft and configured to receive the connection adaptor in a releasably lockable manner.

11. The trimmer unit of claim 10, wherein the housing comprises a lower concave portion having a surface and a circumferential side wall projecting normal to the surface, an upper concave portion including the upper surface of the housing and a circumferential side wall projecting normal to the upper surface, and wherein
the lower and upper concave portions are joined together to define a cavity therebetween.

12. The trimmer unit of claim 11, wherein at least one opening is formed in at least one of the circumferential side walls of the lower and upper concave portions.

13. The trimmer unit of claim 12, wherein a spool of filament is housed in the housing, and a leading end of the spool of filament is pulled out through the opening.

14. The trimmer unit of claim 10, wherein the connection opening includes a substantially circular main portion extending into the housing in a direction normal to the upper surface, and at least one notch extending radially outward of the circular main portion.

15. The trimmer unit of claim 14, wherein the at least one notch comprises first and second notches extending radially outward of the circular main portion in opposite directions.

16. The trimmer unit of claim 14, wherein the connection adaptor includes a main body portion and at least one tab projecting radially outward from the main body portion in a direction normal to the axial direction, and wherein the at least one tab is configured to be inserted into the at least one notch in the connection opening.

17. The trimmer unit assembly of claim 15, wherein the second end of the connection adaptor is threaded.

18. A trimmer unit, comprising:
a shaft having opposite first and second ends;
a connection adaptor having spaced apart first and second ends, and the second end of the connection adaptor connected to the second end of the shaft; and
a cutting head having a housing, the housing including at least an upper surface, and a connection opening formed in the upper surface of the housing and configured to receive the first end of the connection adaptor, wherein
the second end of the connection adaptor is lockably received in the connection opening.
